(19) United States
(12) Patent Application Publication
(10) Pub. No.: US 2011/0191616 A1
(43) Pub. Date: Aug. 4, 2011

(54) USB POWER MANAGING SYSTEM AND METHOD THEREOF

(75) Inventor: Ching-Wei Cheng, Keelung City (TW)

(73) Assignee: ACTION STAR ENTERPRISE CO., LTD., Sijhih (TW)

(21) Appl. No.: 12/959,511

(22) Filed: Dec. 3, 2010

Related U.S. Application Data
(60) Provisional application No. 61/300,879, filed on Feb. 3, 2010.

(51) Int. Cl. G06F 1/32

(52) U.S. Cl. 713/323

(57) ABSTRACT

The present invention relates to a USB power managing system and a method thereof, the USB power managing system comprises an USB peripheral device and an USB interface, wherein the USB interface includes: a micro controlling unit; a data switch coupled to the micro controlling unit; an USB connecting unit coupled to the data switch; and a power switch coupled to the micro controlling unit and the USB connecting unit; wherein when the USB peripheral device is coupled to the USB connecting unit, the micro controlling unit switches the power switch for providing a power the USB peripheral device through the USB connecting unit; moreover when the USB peripheral device enters a standby mode, the micro controlling unit turns off the power switch for stopping providing the power to the USB peripheral device.

### CROSS-REFERENCE TO RELATED APPLICATIONS

This application claims priority from a co-pending U.S. Provisional Patent Application Ser. No. 61/300,879, filed Feb. 3, 2010, the entire content of which is incorporated herein by reference.

### BACKGROUND OF THE INVENTION

1. Technical Field

The present invention relates to an USB system, and more particularly, to an USB power managing system and a method thereof.

2. Description of Related Art

With the development of the computer technology, USB peripheral devices related to the computer are expensively applied and used, for example, keyboard, mouse, printer, data storing device, etc. Generally, a desktop computer or a notebook are built-in an USB interface for connecting the USB peripheral device, so that the computer is able to communicate with the USB peripheral device and transmit data or signal to the USB peripheral device through the USB interface. The USB interface has an USB host used for controlling the communication and the data transmission between the computer and the USB peripheral device. Moreover, when the USB peripheral device is connected to the USB interface, the USB host provides a 5V power to the USB peripheral device, so as to make the USB peripheral device ready to work.

For conventional computer system, a single computer is always connected to multi USB peripheral devices. So that, based on this reason, computer venders propose the USB hub adopted for connecting the multi USB peripheral devices. The USB hub also includes at least one USB host for controlling the communication and the data transmission between the computer and the USB peripheral devices. Please refer to FIG. 1, which illustrates a framework diagram of a conventional USB hub; as shown in FIG. 1, the conventional USB hub 1′ includes: a micro-control unit 11′, a plurality of switch units 12′, a plurality of first USB connecting units 13′, and a second USB connecting unit 14′, wherein the second USB connecting unit 14′ is connected to a computer 2′, and the first USB connecting units 13 are used for receiving the USB peripheral devices 3′. The micro-control unit 11′ is the USB host and able to switch the plurality of switch units 12′, so as to electrically connect the computer 2′ to the USB peripheral devices 3′ connected to the first USB connecting units 13; therefore, the computer 2′ can transmit data and signal to the USB peripheral devices 3′ through the first USB connecting units 13′.

However, according to the above description, it is able to know that the USB interface built-in the computer and the conventional USB hub not include a power managing device. So that, the 5V power is continuously provided to the USB peripheral devices even if the USB peripheral devices are in standby mode. At this time, unnecessary power consumption will be happened. Accordingly, in view of the conventional USB interface and USB hub still have shortcomings and drawbacks, the inventor of the present application has made great efforts to make inventive research thereon and eventually provided a USB power managing system and a method thereof.

### BRIEF SUMMARY OF THE INVENTION

The primary objective of the present invention is to provide a USB power managing system, capable of being implemented to a computer or an USB hub, so as to efficiently manage the power provided to the USB peripheral devices connected to the computer or the USB hub, such that the unnecessary power consumption can be avoided.

The second objective of the present invention is to provide a USB power managing method, the method is applied to an USB power managing system built-in a computer or a USB hub, such that the USB power managing system is able to efficiently manage the power provided to a connected USB peripheral device.

Accordingly, to achieve the abovementioned primary objective, the inventor proposes a USB power managing system, comprising an USB interface, the USB interface comprising: a micro-control unit, a data switch unit, an USB connecting unit, and a power switch unit, wherein the data switch unit is coupled to the micro-control unit, the USB connecting unit is coupled to the data switch unit, and the power switch unit is coupled to the micro-control unit and the USB connecting unit. When an USB connecting interface of an external USB peripheral device is connected to the USB connecting unit, the micro-control unit switches the power switch unit and provides a power to the USB peripheral device through the USB connecting unit, and the data switch unit conducts the micro-control unit and the USB peripheral device via the USB connecting unit; moreover, when the USB peripheral device enters a standby mode, the micro-control unit turns off the power switch unit, so as to stop provides the power to the USB peripheral device.

Moreover, to achieve the abovementioned second objective, the inventor proposes a USB power managing method, comprising steps of: (1) connecting an USB connecting interface of an USB peripheral device to an USB connecting unit of an USB interface; (2) a micro-control unit activating the USB connecting unit connected with the USB peripheral device through a data switch unit; (3) the micro-control unit switching a power switch unit and providing a power to the USB peripheral device via the USB connecting unit, so as to make USB peripheral device ready to work; (4) the data switch unit conducting the micro-control unit and the USB peripheral device, such that the micro-control unit communicates with the USB peripheral device and capable of transmitting data and signal to the USB peripheral device; (5) determining whether the data transmission between the data switch unit and the USB peripheral device is stopped after a particular time period, if yes, proceeding to step (7), otherwise, proceeding to step (6); (6) the micro-control unit continuously communicating with the USB peripheral device via the USB connecting unit and transmitting data and signal through the data switch unit; and (7) the micro-control unit turning off the power switch unit and stopping the power purveyance of the USB peripheral device.

### BRIEF DESCRIPTION OF THE SEVERAL VIEWS OF THE DRAWINGS

The invention as well as a preferred mode of use and advantages thereof will be best understood by referring to the following detailed description of an illustrative embodiment in conjunction with the accompanying drawings, wherein:

FIG. 1 is a framework diagram of a conventional USB hub;

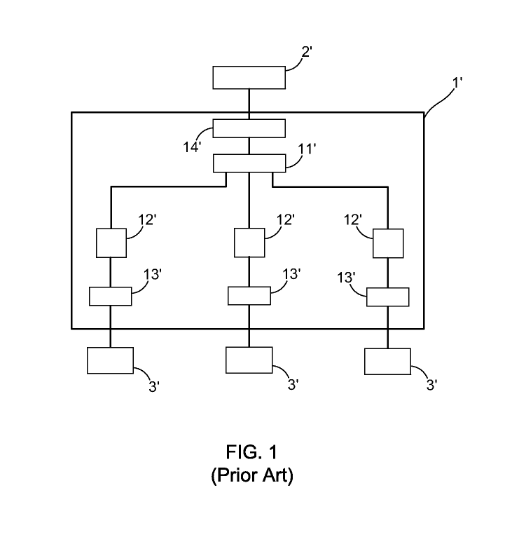

FIG. 2 is the framework diagram of a USB power managing system according to the present invention;

FIG. 3 is the framework diagram of a second embodiment of the USB power managing system according to the present invention;

FIG. 4 is the framework diagram of a third embodiment of the USB power managing system according to the present invention;

FIG. 5 is the framework diagram of a fourth embodiment of the USB power managing system according to the present invention;

FIG. 6 is the framework diagram of a fifth embodiment of the USB power managing system according to the present invention; and

FIG. 7 is a flow chart of a USB power managing method according to the present invention.

### DETAILED DESCRIPTION OF THE INVENTION

To more clearly describe an USB power managing system and a method thereof according to the present invention, embodiments of the present invention will be described in detail with reference to the attached drawings hereinafter.

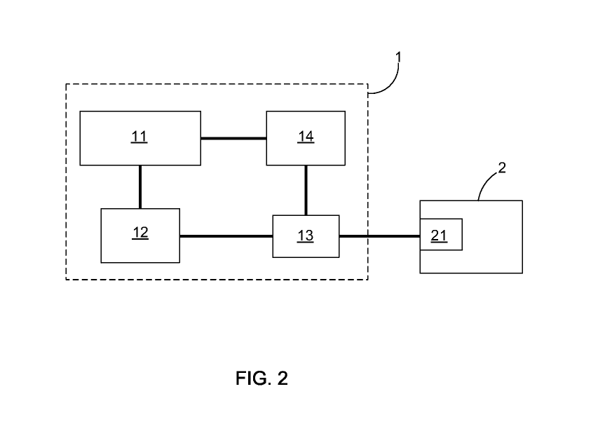

Please Refer to FIG. 2, which illustrates a framework diagram of a USB power managing system according to the present invention. As shown in FIG. 2, the USB power managing system has an USB interface, the USB interface includes: a micro-control unit 11, a data switch unit 12, an USB connecting unit 13, and a power switch unit 14, wherein the data switch unit 12 is coupled to the micro-control unit 11, the USB connecting unit 13 is coupled to the data switch unit 12, and the power switch unit 14 is coupled to the micro-control unit 11 and the USB connecting unit 13.

The USB power managing system of the present invention can be built-in a computer or an USB hub for connecting an external USB peripheral device 2. As shown in FIG. 2, when an USB connecting interface 21 of the USB peripheral device 2 is connected to the USB connecting unit 13 of the USB interface 1, the micro-control unit 11 switches the power switch unit 14 and provides a power to the USB peripheral device 2 through the USB connecting unit 13, and the data switch unit 12 conducts the micro-control unit 11 and the USB peripheral device 2 via the USB connecting unit 13; moreover, when the USB peripheral device enters a standby mode, the micro-control unit turns off the power switch unit, so as to stop provides the power to the USB peripheral device; meanwhile, the micro-control unit 11 is able to transmit data and signal to the USB peripheral device 2 through the data switch unit 12. Moreover, when the USB peripheral device 2 enters a standby mode, the micro-control unit 11 turns off the power switch unit 14 and stops the power purveyance of the USB peripheral device 2. Therefore, when the USB peripheral device 2 is in the standby condition, it can prevent the USB interface 1 from continuously outputting the power to the USB peripheral device 2, and unnecessary power consumption can be avoided.

It is necessary to note that, when the data transmission between the data switch unit 12 and the USB peripheral device 2 is stopped after a particular time period, the micro-control unit 11 defines that the USB peripheral device 2 enters the standby mode, so that the micro-control unit 11 further turns off the power switch unit 14 and stops providing the power to the USB peripheral device 2.

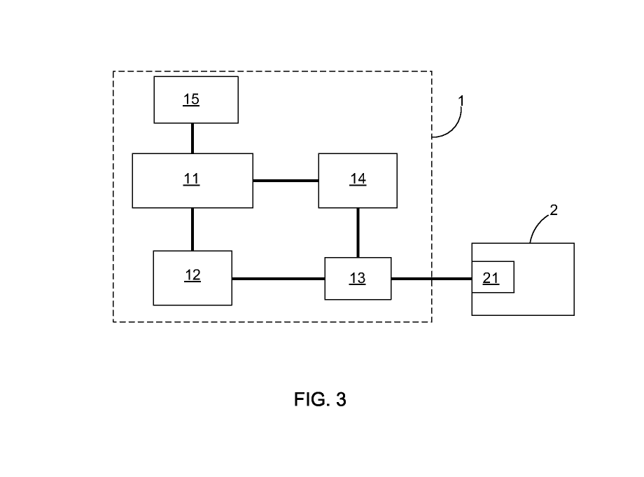

The USB power managing system of the present invention further has a second embodiment, please refer to FIG. 3, which illustrates the framework diagram of the second embodiment of the USB power managing system according to the present invention. As shown in FIG. 3, by way of adding a detecting circuit 15 into the framework of the first embodiment, the second embodiment of the USB power managing system is carried out. The detecting circuit 15 is coupled to the micro-control unit 11 and adopted for determining whether the USB peripheral device 2 enters the standby mode by detecting the data transmission between the micro-control unit 11 and the USB peripheral device 2.

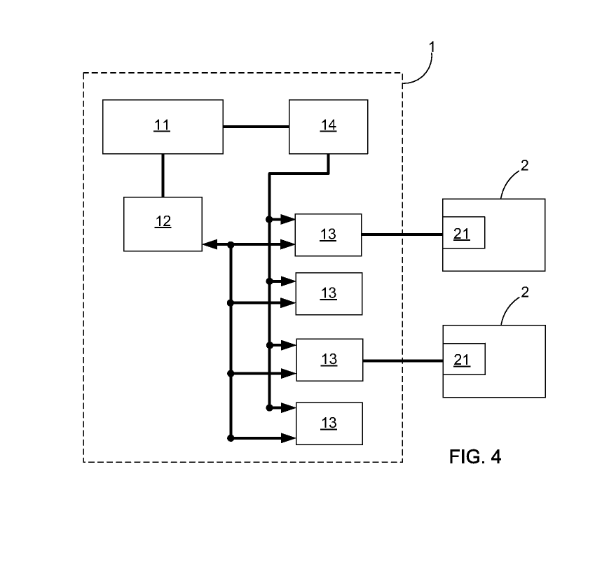

Moreover, The USB power managing system of the present invention further includes a third embodiment, please refer to FIG. 4, which illustrates the framework diagram of the third embodiment of the USB power managing system according to the present invention. Since the USB power managing system can be implemented into a computer or an USB hub for managing the external USB peripheral device 2. Thus, it is easily to know that, in order to make the computer or the USB hub can connect and use multi USB peripheral device 2, the USB power managing system must include multi USB connecting unit 13. Therefore, as shown in FIG. 4, the third embodiment of the USB power managing system includes the multi USB connecting units 13 for receiving the USB connecting interfaces 21 of the USB peripheral devices 2.

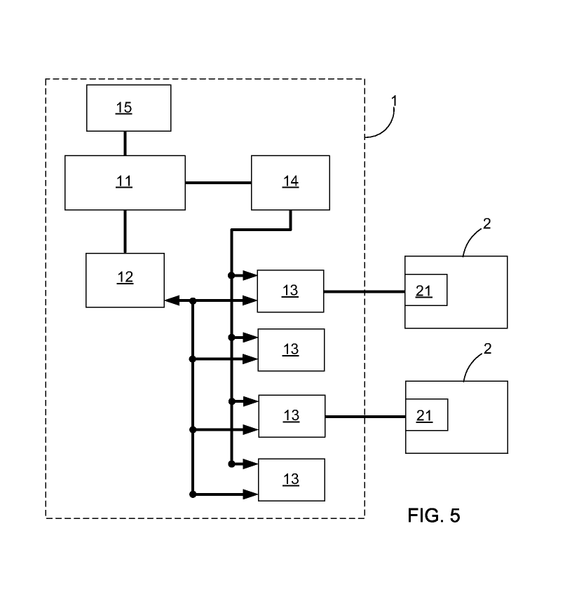

In addition, the USB power managing system further has a fourth embodiment. Please refer to FIG. 5, which illustrates the framework diagram of the fourth embodiment of the USB power managing system according to the present invention. As shown in FIG. 5, by way of adding a detecting circuit 15 into the framework of the third embodiment, the fourth embodiment of the USB power managing system is completed. In the framework of the fourth embodiment of the USB power managing system, the detecting circuit 15 is coupled to the micro-control unit 11, and is used to determining whether the USB peripheral device 2 enters the standby mode by detecting the data transmission between the micro-control unit 11 and the USB peripheral device 2.

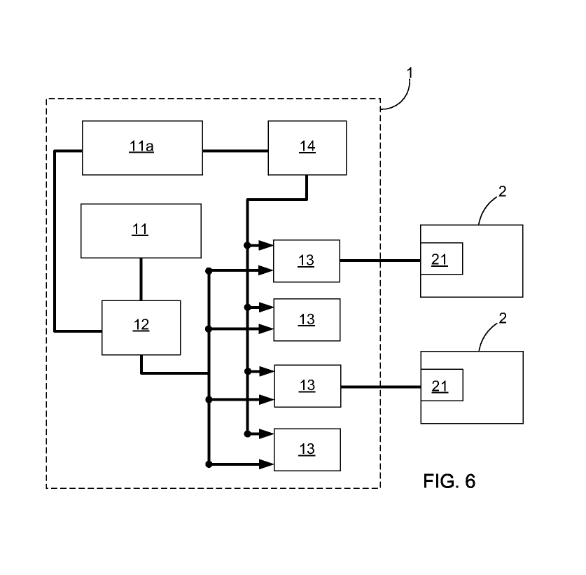

Furthermore, the USB power managing system further has a fifth embodiment. Please refer to FIG. 6, which illustrates the framework diagram of the fifth embodiment of the USB power managing system according to the present invention. Since the USB power managing system can be applied to the USB hub, thus, for making the USB power managing system perform efficiently, a second micro-control unit 11a is added into the framework of the above-mentioned third embodiment, such that the fifth embodiment of USB power managing system is obtained. As shown in FIG. 6, in the fifth embodiment of USB power managing system, the second micro-control unit 11a is coupled to the power switch unit 14 and the data switch unit 12. However, distinguishing from the third embodiment, in the fifth embodiment of USB power managing system, the micro-control unit 11 is not connected to the power switch unit 14.

Therefore, through the framework of the fifth embodiment of the USB power managing system, when the USB peripheral device 2 is connected to the USB connecting unit 13, the second micro-control unit 11a switched the power switch unit 14 and provides the power to the USB peripheral device 2, and the second micro-control unit 11a further activates the data switch unit 12; meanwhile, the micro-control unit 11 is able to transmit data and signal to the USB peripheral device 2 through the data switch 12. Moreover, when the USB peripheral device 2 enters the standby mode, the second micro-control unit 11a turns off the power switch unit 14 and stops providing the power to the USB peripheral device 2, and the second micro-control unit 11a further turns off the data switch unit 12.

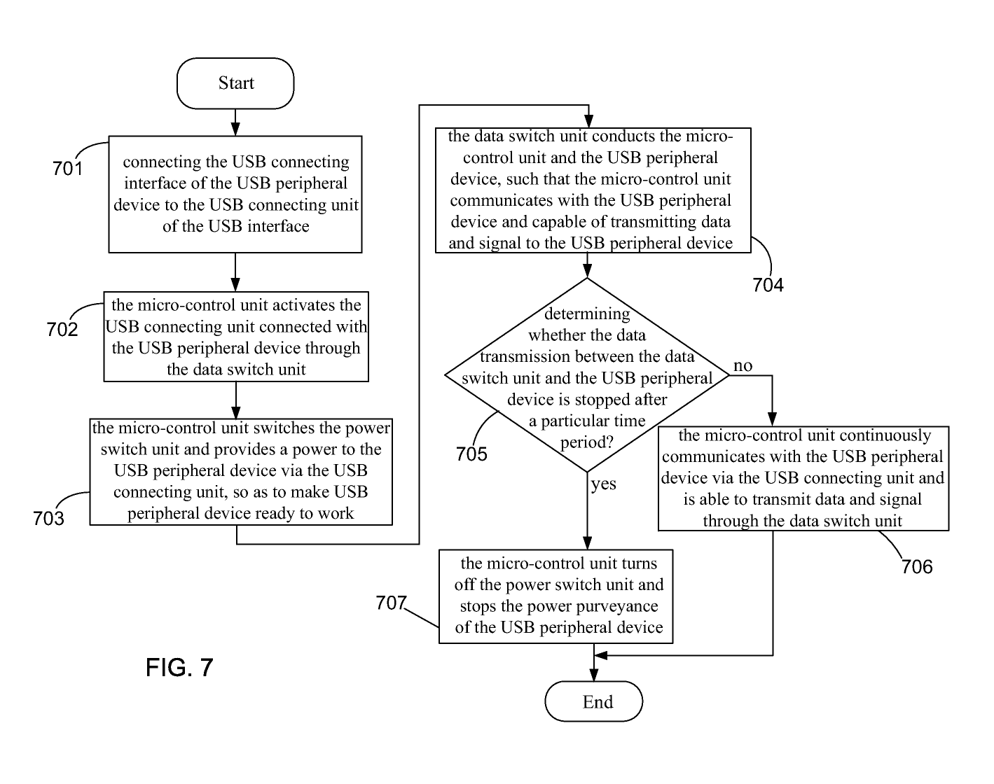

With reference to FIG. 7, a flow chart of a USB power managing method according to the present invention is illustrated. In the present invention, it further proposes a USB power managing method, as shown in FIG. 7, the method includes steps of:

Firstly, the method flow is proceeded to step (701), connecting the USB connecting interface 21 of the USB peripheral device 2 to the USB connecting unit 13 of the USB interface 1. Next proceeding to step (702), the micro-control unit 11 activates the USB connecting unit 13 connected with the USB peripheral device 2 through the data switch unit 12. Next proceeding to step (703), the micro-control unit 11 switches the power switch unit 14 and provides a power to the USB peripheral device 2 via the USB connecting unit 13, so as to make USB peripheral device 2 ready to work, and then proceeding to step (704), the data switch unit 12 conducts the micro-control unit 11 and the USB peripheral device 2, such that the micro-control unit 11 communicates with the USB peripheral device 2 and capable of transmitting data and signal to the USB peripheral device 2.

The method flow continuously proceeds to step (705), determining whether the data transmission between the data switch unit 12 and the USB peripheral device 2 is stopped after a particular time period, if yes, proceeding to step (707), otherwise, proceeding to step (706). When the method flow is proceeded to step (706), such that the micro-control unit 11 continuously communicates with the USB peripheral device 2 via the USB connecting unit 13 and is able to transmit data and signal through the data switch unit 12. When the method flow is proceeded to step (707), the micro-control unit turns off the power switch unit 14 and stops the power purveyance of the USB peripheral device 2. It is necessary to note that the determine of the step (705) can be executed by the detecting circuit or the micro-control unit 11.

Thus, the USB power managing system and the method thereof according to the present invention have been disclosed completely and clearly in the above description. In summary, the present invention has the following advantages:
1. The USB power managing system is able to be built-in a computer or an USB hub, and used to connect the USB peripheral device as well as further manage the power provided to the USB peripheral device.
2. The USB power managing system has multi embodiment for various appellations.
3. The USB power managing method is applied to the USB power managing system built-in the computer or the USB hub, such that the USB power managing system is able to efficiently manage the power provided to a connected USB peripheral device.

The above description is made on embodiments of the present invention. However, the embodiments are not intended to limit scope of the present invention, and all equivalent implementations or alterations within the spirit of the present invention still fall within the scope of the present invention.

I claim:

1. A USB power managing system, comprising an USB interface, the USB interface comprising:
a micro-control unit;
a data switch unit, being coupled to the micro-control unit;
an USB connecting unit, being coupled to the data switch unit; and
a power switch unit, being coupled to the micro-control unit and the USB connecting unit;
wherein when an USB connecting interface of an external USB peripheral device is connected to the USB connecting unit, the micro-control unit switching the power switch unit and providing a power to the USB peripheral device through the USB connecting unit, and the data switch unit conducting the micro-control unit and the USB peripheral device via the USB connecting unit; moreover, when the USB peripheral device enters a standby mode, the micro-control unit turning off the power switch unit, so as to stop providing the power to the USB peripheral device.

2. The USB power managing system of claim 1, further comprising a detecting circuit coupling to the micro-control unit, the detecting circuit being able to determine whether the USB peripheral device enters the standby mode by detecting the data transmission between the micro-control unit and the USB peripheral device.

3. The USB power managing system of claim 2, wherein when the USB peripheral device is connected to the USB connecting unit, the micro-control unit activating the USB connecting unit through the data switch unit.

4. The USB power managing system of claim 2, wherein when the data transmission between the data switch unit and the USB peripheral device is stopped after a particular time period, the USB peripheral device enters the standby mode.

5. A USB power managing system, comprising an USB interface, the USB interface comprising:
a micro-control unit;
a data switch unit, being coupled to the micro-control unit;
a plurality of USB connecting units, being coupled to the data switch unit; and
a power switch unit, being coupled to the micro-control unit and the plurality of USB connecting units;
wherein when at least one external USB peripheral devices are connected to the USB connecting units and coupled to the USB interface, the micro-control unit switching the power switch unit and providing a power to each of the USB peripheral devices through the USB connecting units, and the data switch unit conducting the micro-control unit and the at least one USB peripheral devices via the USB connecting units; moreover, when the at least one USB peripheral devices enter a standby mode, the micro-control unit turning off the power switch unit, so as to stop providing the power to the USB peripheral devices.

6. The USB power managing system of claim 5, further comprising a detecting circuit coupling to the micro-control unit, the detecting circuit being able to determine whether the at least one USB peripheral devices enter the standby mode by detecting the data transmission between the micro-control unit and the USB peripheral devices.

7. The USB power managing system of claim 6, wherein when the at least one USB peripheral devices are connected to the USB connecting unit, the micro-control unit activating the USB connecting units through the data switch unit.

8. The USB power managing system of claim 6, wherein when the data transmission between the data switch unit and the at least one USB peripheral devices is stopped after a particular time period, the USB peripheral devices enter the standby mode.

9. A USB power managing method, comprising steps of:
(1) connecting an USB connecting interface of an USB peripheral device to an USB connecting unit of an USB interface;
(2) a micro-control unit activating the USB connecting unit connected with the USB peripheral device through a data switch unit;
(3) the micro-control unit switching a power switch unit and providing a power to the USB peripheral device via the USB connecting unit, so as to make USB peripheral device ready to work;
(4) the data switch unit conducting the micro-control unit and the USB peripheral device, such that the micro-control unit communicates with the USB peripheral device and capable of transmitting data and signal to the USB peripheral device;
(5) determining whether the data transmission between the data switch unit and the USB peripheral device is stopped after a particular time period, if yes, proceeding to step (7), otherwise, proceeding to step (6);
(6) the micro-control unit continuously communicating with the USB peripheral device via the USB connecting unit and being able to transmit data and signal through the data switch unit; and
(7) the micro-control unit turning off the power switch unit and stopping the power purveyance of the USB peripheral device.

10. The USB power managing method of claim 9, wherein the USB interface is built-in a computer.

11. The USB power managing method of claim 9, wherein the USB interface is built-in a USB hub.

12. The USB power managing method of claim 9, wherein the micro-control unit is used to determine whether the data transmission between the data switch unit and the USB peripheral device is stopped.

13. The USB power managing method of claim 9, wherein the detecting circuit unit is used to determine whether the data transmission between the data switch unit and the USB peripheral device is stopped.
